(19) United States
(12) Patent Application Publication
(10) Pub. No.: US 2020/0411033 A1
(43) Pub. Date: Dec. 31, 2020

(54) CONVERSATION ASPECT IMPROVEMENT

(71) Applicant: Lenovo (Singapore) Pte. Ltd., Singapore (SG)

(72) Inventors: Ming Qian, Cary, NC (US); Song Wang, Cary, NC (US); Jian Li, Chapel Hill, NC (US); Yang Wang, Cary, NC (US)

(21) Appl. No.: 16/454,184

(22) Filed: Jun. 27, 2019

(51) Int. Cl. G10L 25/48; G06F 17/27

(52) U.S. Cl. CPC G10L 25/48; G06F 17/2765; G06F 17/2705

(57) ABSTRACT

One embodiment provides a method, including: analyzing, using a digital assistant, a conversation between at least two users; identifying, using a processor, an improvement opportunity related to the conversation; and presenting, based on the identified improvement opportunity, a suggestion to improve an aspect of the conversation. Other aspects are described and claimed.

### BACKGROUND

Individuals often utilize information handling devices (“devices”), for example, smart phones, tablet devices, laptop and/or personal computers, and the like, to communicate with other individuals. For instance, individuals may have voice conversations with other individuals over the phone or by utilizing a voice-based communication application. During the conversation, the individuals may schedule a future meeting, discuss an important matter, etc.

### BRIEF SUMMARY

In summary, one aspect provides a method, comprising: analyzing, using a digital assistant, a conversation between at least two users; identifying, using a processor, an improvement opportunity related to the conversation; and presenting, based on the identified improvement opportunity, a suggestion to improve an aspect of the conversation.

Another aspect provides an information handling device, comprising: a processor; a memory device that stores instructions executable by the processor to: analyze, using a digital assistant of the information handling device, a conversation between at least two users; identify an improvement opportunity related to the conversation; and present, based on the identified improvement opportunity, a suggestion to improve an aspect of the conversation.

A further aspect provides a product, comprising: a storage device that stores code, the code being executable by a processor and comprising: code that analyzes a conversation between at least two users; code that identifies an improvement opportunity related to the conversation; and code that presents, based on the identified improvement opportunity, a suggestion to improve an aspect of the conversation.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of providing a suggestion using a digital conversational assistant to improve an aspect of a conversation.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Concepts often do not get communicated clearly in conversations between individuals, especially in conversations occurring over devices. A number of factors may be responsible for the lack of conversation clarity. For example, in a situation where an individual must make a decision (e.g., when scheduling an appointment with a doctor, etc.) the volume of information necessary to make a decision may be so large that it may overwhelm the individual. This issue may be exacerbated if the information is not presented in a clear and logical way. Additional factors may also affect the clarity of the conversation such as generational dialogue differences, cultural differences, accent differences, and the like. No conventional solutions currently exist for optimizing the clarity of a conversation between individuals.

Accordingly, an embodiment provides a method for providing a suggestion using a digital conversational assistant to improve an aspect of a conversation between individuals. In an embodiment, a conversation between two or more users may be detected and analyzed. The analysis may be conducted by a digital conversational assistant robot (“digital assistant”). An embodiment may then identify an improvement opportunity related to the conversation. The improvement opportunity may correspond to a conversation structure, a user's speech delivery, a confusion indication, and the like. Thereafter, an embodiment may present a suggestion to improve an aspect of the conversation based upon the identified improvement opportunity. Such a method may help make conversations clearer and more orderly.

The illustrated example embodiments will be best understood by reference to the figures. The following description is intended only by way of example, and simply illustrates certain example embodiments.

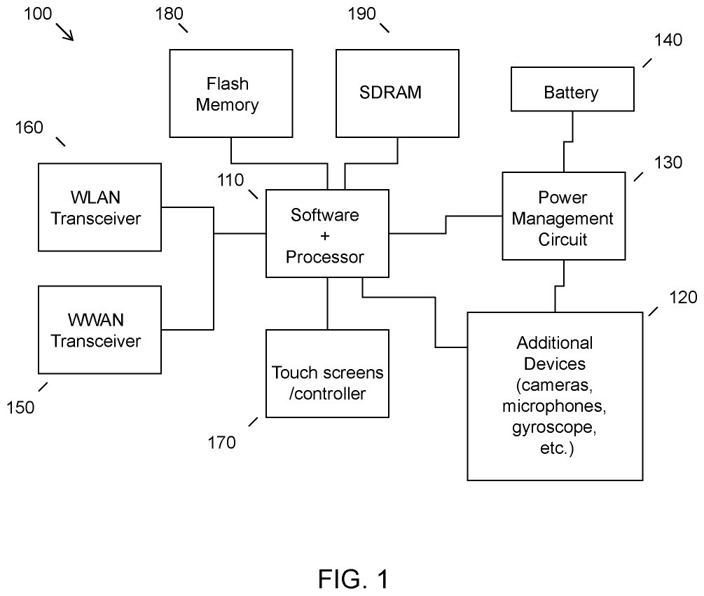

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, motion sensor such as an accelerometer or gyroscope, etc. System 100 often includes one or more touch screens 170 for data input and display/rendering. System 100 also typically includes various memory devices, for example flash memory 180 and SDRAM 190.

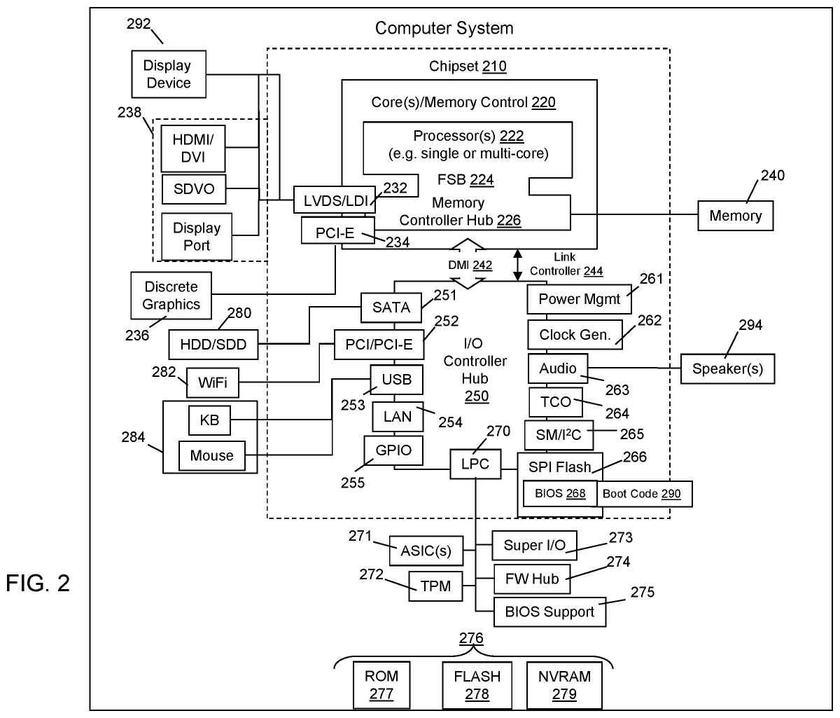

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, laptops and/or personal computers, hybrid devices, and/or other electronic devices that may be capable of conducting a conversation with another individual and/or capable of supporting a digital assistant capable of analyzing the conversation. For example, the circuitry outlined in FIG. 1 may be implemented in a tablet or smart phone embodiment, whereas the circuitry outlined in FIG. 2 may be implemented in a laptop.

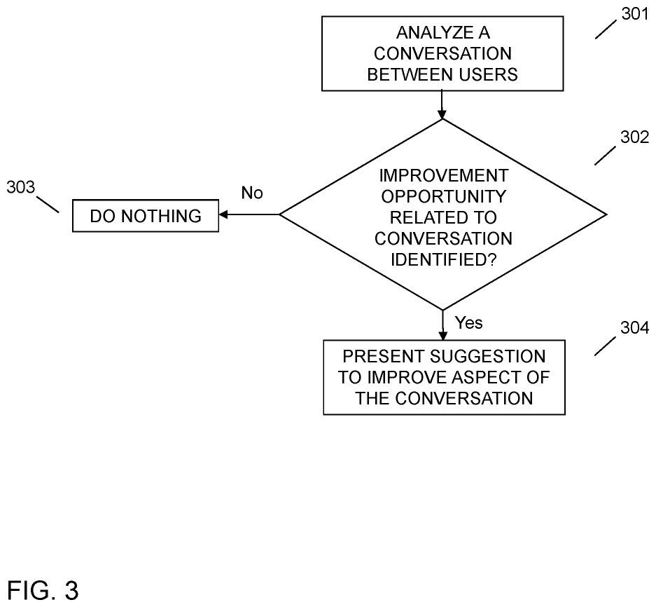

Referring now to FIG. 3, an embodiment may present a suggestion to improve an aspect of a conversation between two or more individuals. At 301, an embodiment may analyze a conversation between at least two users. In an embodiment, the conversation may be an audible conversation (e.g., a voice conversation, etc.) or a text-based conversation (e.g., a conversation occurring in an online chat room, etc.). In an embodiment, the conversation may be occurring over one or more devices. For example, two users may be having an audible conversation over their phones, or a voice-based communication application on their devices, etc. As another example, two users may be having a text-based conversation in an online chat room.

In an embodiment, the conversation may be analyzed by a digital assistant. The digital assistant may be resident on one user's device, both of the user's devices, or on another device in communication with at least one of the user's devices. In an embodiment, the digital assistant may employ one or more conventional audio analysis or text analysis techniques to conduct the analysis. In an embodiment, the digital assistant may be capable of detecting various characteristics associated with the conversation such as the date the conversation occurred, time of day the conversation occurred, location of each individual engaged in the conversation, etc.).

In an embodiment, the digital assistant may begin analysis of the conversation at its outset. Alternatively, in another embodiment, the digital assistant may only begin to analyze the conversation once a predetermined event has occurred (e.g., after a predetermined command is received from a user, after a predetermined time has elapsed, etc.).

At 302, an embodiment may identify an improvement opportunity for the conversation. In the context of this application, an improvement opportunity may be a broad term that refers to one or more aspects of the conversation that may be adjusted in order to better achieve conversational clarity. An embodiment may be trained to recognize different types of improvement opportunities by the original manufacturer or by the user. For instance, in an embodiment, the improvement opportunity may correspond to the conversation structure. For example, an embodiment may identify a goal of the conversation and thereafter identify that the order of topics discussed in the conversation and/or how those topics are presented may not be the best to achieve the goal.

In another embodiment, an improvement opportunity may correspond to a user's speech delivery. For example, an embodiment may identify if a user is using any or an excess number of inappropriate words (e.g., “swear” words, culturally insensitive words, etc.) based upon the conversational context (e.g., a formal conversation with one or more other professionals, casual conversation with friends, etc.). As another example, an embodiment may identify that a user is providing speech too fast or too slow based upon their audience (e.g., if one of the participants is from a different culture, speaks a different primary language, is too old or too young, etc.). As another example, an embodiment may identify that a user's speech is too choppy or segmented (e.g., broken up by audible or inaudible pauses, etc.).

In another embodiment, an improvement opportunity may correspond to a confusion indication. For instance, an embodiment may determine that one or more participants in the conversation are confused by monitoring for key words or actions. For example, if one participant asks another “does that make sense?” or “do you understand” and the other participant responds “no” or “not really”, an embodiment may determine that the secondary participant is confused.

Responsive to not identifying, at 302, an improvement opportunity, an embodiment may, at 303, take no further action. More particularly, an embodiment may not provide any output to any conversational participant and/or may continue to analyze the conversation between participants until an improvement opportunity is identified. Conversely, responsive to identifying, at 302, an improvement opportunity, an embodiment may, at 304, present a suggestion to improve an aspect of the conversation based upon the identified improvement opportunity. In an embodiment, the suggestion may be presented to the user visually, audibly, a combination thereof, and the like.

Responsive to identifying that the conversation structure may be improved and/or that one or more other participants are being confused by the current conversation structure, an embodiment may provide a user with one or more suggestions on how to reorganize the conversation. For example, if a digital assistant identifies that a user has provided another user with a large block of information, the digital assistant may suggest that the user segment the information block into subsets and ask other participants to confirm their understanding of the information subset before continuing. Additionally or alternatively, the digital assistant may provide the user with the actual information subsets based upon its analysis and understanding of the information presented. In another embodiment, the digital assistant may recommend re-organizing aspects of the conversation upon re-delivery (e.g., present Topics B and C before Topic A, etc.). Additionally or alternatively, the digital assistant may recommend deleting various aspects of the conversation because they are superfluous or confusing.

Responsive to identifying that a user's speech delivery may be improved, an embodiment may provide a variety of different types of suggestions based upon the context of improvement. For example, if a user was using inappropriate or insensitive words for the conversation context, an embodiment may recommend that the user cease use of these words throughout the rest of the conversation. As another example, if a user was speaking too fast based upon the conversation context, an embodiment may recommend that the user adjust their speech speed. Additionally or alternatively, in yet another example, an embodiment may notify a user that they are pausing too much in the conversation and may recommend that the user make a conscious effort not to do so.

In an embodiment, the digital assistant may make proactive suggestions to the user. More particularly, the digital assistant may make suggestions, or provide the user with notifications, before a conversation even begins. For example, based upon the identified locations, cultural or ethnic backgrounds, or age groups of one or more of the conversation participants, an embodiment may recommend to the user to: not use certain words known to offend individuals associated with those locations or age groups, tailor their speech speed based upon this information, etc. Additionally or alternatively, if an embodiment knows a goal of a conversation before it begins (e.g., to schedule an appointment with a doctor's office, etc.), an embodiment may proactively provide a user with a template for conducting the conversation (e.g., first ask about their availability during the week, then ask about their morning or afternoon appointment preferences, etc.).

The various embodiments described herein thus represent a technical improvement to conventional conversation improvement techniques. Using the techniques described herein, an embodiment may first utilize a digital assistant to analyze a conversation occurring between at least two participants. An embodiment may then identify an improvement opportunity related to the conversation. For example, an embodiment may identify that the conversation structure may be improved, words used in the conversation may be changed, speed of the conversation may be adjusted, etc. Thereafter, an embodiment may present a suggestion to improve an aspect of the conversation. For example, an embodiment may suggest that: certain aspects of the conversation be delivered before others, a user not use certain words, a user speak at a certain speech rate, etc. Such a method may improve the conversation quality between conversation participants.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
analyzing, using a digital assistant, a conversation between at least two users;
identifying, using a processor, an improvement opportunity related to the conversation; and
presenting, based on the identified improvement opportunity, a suggestion to improve an aspect of the conversation.

2. The method of claim 1, wherein the conversation between the at least two users occurs over devices associated with the at least two users.

3. The method of claim 1, wherein the improvement opportunity corresponds to a structure of conversational topics.

4. The method of claim 3, wherein the presenting the suggestion comprises presenting an alternative organization of the conversational topics.

5. The method of claim 1, wherein the improvement opportunity corresponds to speech delivery by at least one of the at least two users.

6. The method of claim 5, wherein the presenting the suggestion comprises recommending that the user: utilize alternative words, adjust a speed of the user's speech, and eliminate pauses.

7. The method of claim 1, wherein the improvement opportunity corresponds to a confusion indication.

8. The method of claim 7, wherein the presenting the suggestion comprises clarifying a source of confusion associated with the confusion indication.

9. The method of claim 1, wherein the presenting comprises presenting the suggestion to a device associated with one of the at least two users.

10. The method of claim 1, further comprising providing a proactive suggestion for another conversation based on the improvement opportunity

11. An information handling device, comprising:
a processor;
a memory device that stores instructions executable by the processor to:
analyze, using a digital assistant of the information handling device, a conversation between at least two users;
identify an improvement opportunity related to the conversation; and
present, based on the identified improvement opportunity, a suggestion to improve an aspect of the conversation.

12. The information handling device of claim 11, wherein the conversation between the at least two users occurs over at least the information handling device.

13. The information handling device of claim 11, wherein the improvement opportunity corresponds to a structure of conversational topics.

14. The information handling device of claim 13, wherein the instructions executable by the processor to present the suggestion comprise instructions executable by the processor to present an alternative organization of the conversational topics.

15. The information handling device of claim 11, wherein the improvement opportunity corresponds to speech delivery by at least one of the at least two users.

16. The information handling device of claim 15, wherein the instructions executable by the processor to present the suggestion comprise instructions executable by the processor to recommend that the user: utilize alternative words, adjust a speed of the user's speech, and eliminate pauses.

17. The information handling device of claim 11, wherein the improvement opportunity corresponds to a confusion indication.

18. The information handling device of claim 17, wherein the instructions executable by the processor to present the suggestion comprise instructions executable by the processor to clarify a source of confusion associated with the confusion indication.

19. The information handling device of claim 11, wherein the instructions executable by the processor to present comprise instructions executable by the processor to present the suggestion to a device associated with one of the at least two users.

20. A product, comprising:
a storage device that stores code, the code being executable by a processor and comprising:
code that analyzes a conversation between at least two users;
code that identifies an improvement opportunity related to the conversation; and
code that presents, based on the identified improvement opportunity, a suggestion to improve an aspect of the conversation.
